(19) United States
(12) Patent Application Publication
(10) Pub. No.: US 2011/0187705 A1
(43) Pub. Date: Aug. 4, 2011

(54) METHOD FOR DISPLAYING STEREOSCOPIC IMAGES

(76) Inventors: Tung-Hsin Lan, Taipei City (TW); Mu-Shan Liao, Changhua County (TW); Chun-Chieh Chiu, Taoyuan County (TW); Tien-Yung Huang, Pingtung County (TW)

(21) Appl. No.: 12/764,108

(22) Filed: Apr. 21, 2010

(30) Foreign Application Priority Data
Feb. 1, 2010 (TW) 099102787

(51) Int. Cl. G06F 3/038

(52) U.S. Cl. 345/419; 345/213

(57) ABSTRACT

A stereoscopic image displaying method provides a data driving signal related to a right-eye image and a left-eye image. During a plurality of frame periods, the data driving signal switches polarities every m frame periods, wherein m is an integer larger than 1. The right-eye image is outputted during the odd-numbered frame periods among the plurality of frame periods, while the left-eye image is outputted during the even-numbered frame periods among the plurality of frame periods.

### BACKGROUND OF THE INVENTION

1. Field of the Invention

The present invention is related to a method for displaying stereoscopic images, and more particularly, to a method for displaying stereoscopic images using an LCD device.

2. Description of the Prior Art

Three-dimensional (3D) display technology provides more vivid visual experiences than traditional two-dimensional (2D) display technology. In three-dimensional display technology, right-eye images and left-images are transmitted to left eye and right eye, respectively. Due to different viewing angles of the two eyes, the overlapped right-eye images and left-images in human brain thus create stereoscopic images in human perception. Common methods for displaying stereoscopic images include those using polarizing glasses, shutter glasses and anaglyph. When displaying stereoscopic images using polarizing glasses (such as in I-MAX theaters), the left-eye lens and the right-eye lens are alternatively switched on and off: when the right-eye lens is switched on, corresponding right-eye images are simultaneously displayed on the screen; when the left-eye lens is switched on, corresponding left-eye images are simultaneously displayed on the screen. Regardless of the types of display methods, it is required to provide right-eye images and left-eye image, which, although both related to the same image signal, have different depths.

Among various types of display devices, liquid crystal display (LCD) devices are advantageous in thin appearance, low power consumption and radiation-free. An LCD device displays images having different grayscale values by rotating liquid crystal molecules. If the LCD device is driven using direct current (DC) means, ions of the liquid crystal materials are constantly drawn to ITO (indium tin oxide) glass in the same direction under the influence of electrical field. The kind of polarization, known as DC residual phenomenon, generates another electrical field which may impact the rotation of liquid crystal molecules. In order to prevent DC residual phenomenon from downgrading display quality, the LCD device is normally driven using alterative current (AC) means in which the data driving signal has opposite polarities in two consecutive frame periods.

FIGS. 1 and 2 are diagrams illustrating a prior art method for displaying stereoscopic images using an LCD device. FIG. 1 shows a gate driving signal SG, a data driving signal SD, a polarity inversion signal POL, a pixel voltage V_{PIXEL}, a left-eye lens-on signal L_{ON} and a right-eye lens-on signal R_{ON}. When column inversion is adopted, the data polarities in frame periods F1-Fn are depicted in FIG. 2.

As depicted in FIG. 1, the data driving signal SD is written into a corresponding pixel during the turn-on periods when the gate driving signal SG is at high level. In other words, the pixel charge time is determined by the pulse width of the gate driving signal SG. According to Full HD standard, for instance, the pulse width of the gate driving signal SG is 14.8 us when the frame frequency is 60 Hz, but is shortened to 7.4 us when the frame frequency is doubled to 120 Hz. Therefore, in high-resolution or high-frequency applications, the pixels may not have sufficient charge time. As depicted in FIG. 1, the pixel voltage V_{PIXEL} may not reach the level of the data driving signal SD during the turn-on period of the gate driving signal SG.

On the other hand, the polarity of the diving period is determined by the polarity inversion signal POL. During the positive driving period, the level of the data driving signal SD is represented by V_{H}; during the negative driving period, the level of the data driving signal SD is represented by V_{L}. The grayscale value of an image to be displayed by a pixel is determined by the voltage difference ΔV between the data driving signal SD and a common voltage V_{COM}, wherein ΔV=(V_{H}−V_{COM}) or (V_{COM}−V_{L}). For NW (normally white) liquid crystal material, a smaller voltage difference ΔV is applied for displaying bright images (such as a white image whose grayscale value is 255), while a larger voltage difference ΔV is applied for displaying dark images (such as a black image whose grayscale value is 0). If the common voltage V_{COM} is 6V, the white image can be displayed by applying a positive driving voltage V_{H} of 7V or a negative driving voltage V_{L} of 5V, while the black image can be displayed by applying a positive driving voltage V_{H} of 11V or a negative driving voltage V_{L} of 1V. In the prior art method for displaying stereoscopic images using an LCD device, each column of pixels for displaying the left-eye images during the odd-numbered frame periods F1, F3, . . . , Fn-1 are driven by signals sequentially having positive polarity, negative polarity, . . . , positive polarity, and negative polarity, while each column of pixels for displaying the right-eye images during the even-numbered frame periods F2, F4, . . . , Fn are driven by signals sequentially having negative polarity, positive polarity, . . . , negative polarity, and positive polarity (assuming n is an even number). The pixels in the striped region are required to display black images having grayscale value of 0, while the pixels in the blank region are required to display white images having grayscale value of 255. Since the left-eye image provided in the odd-numbered frame period F1 and the right-eye image provided in the even-numbered frame period F2 have different viewing angles, the left-eye and right-eye images are overlapped in human brain, which in turn results in a stereoscopic image in human perception, as depicted in FIG. 2.

For the pixel represented by P(2,2) in FIG. 2, the level of the data driving signal SD is equal to the negative-polarity driving voltage V_{L} (1V) of black image in the frame period F1, equal to the positive-polarity driving voltage V_{H} (7V) of white image in the frame period F2, equal to the negative-polarity driving voltage V_{L} (1V) of black image in the frame period F3, . . . , and etc. In other words, the level of the data driving signal SD switches between 1V and 7V, and the voltage difference ΔV thus varies between 1V and 5V. Since the voltages applied to a pixel in the positive and negative driving periods result in a large voltage difference which causes DC residual phenomenon, thereby influencing the display quality of the LCD device.

In the prior art stereoscopic image displaying method of the LCD device, the data driving signal SD switches polarities and the left/right-eye lenses are switched on/off with the same frequency . In other words, the same pixel observed by the same eye is always driven by signals having the same polarity. As shown in FIG. 2, assuming that the right-eye lens is turned on and the left-eye lens is turned off during the odd-numbered frame periods F1, F3, . . . , Fn-1, and that the left-eye lens is turned on and the right-eye lens is turned off during the even-numbered frame periods F2, F4, . . . , Fn. Since the left-eye lens or the right-eye lens receives images of the same polarity, the display quality may be impacted when the positive and negative polarities result in difference values in luminance.

### SUMMARY OF THE INVENTION

The present invention provides a method for displaying stereoscopic images using an LCD device, comprising providing a data driving signal corresponding to a right-eye image and a left-eye image; switching a polarity of the data driving signal every m frame periods during a plurality of frame periods, wherein m is an integer larger than 1; outputting the right-eye image according to the data driving signal during odd-numbered frame periods among the plurality of frame periods; and outputting the left-eye image according to the data driving signal during even-numbered frame periods among the plurality of frame period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 and 2 are diagrams illustrating a prior art method for displaying stereoscopic images using an LCD device.

FIGS. 3-6 are diagrams illustrating methods for displaying stereoscopic images using an LCD device according to the present invention.

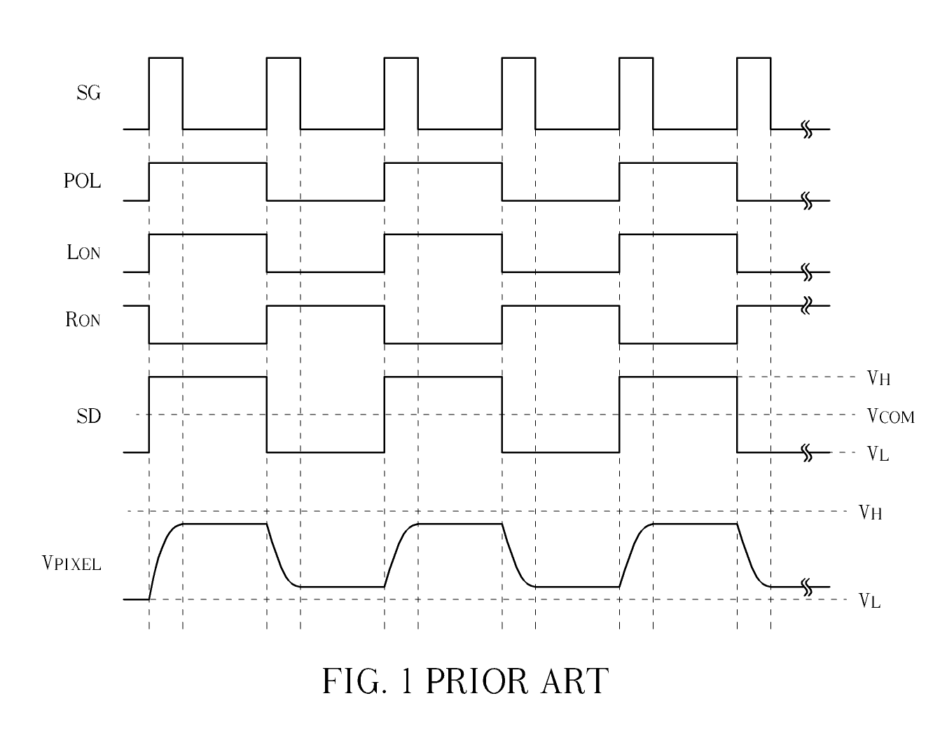

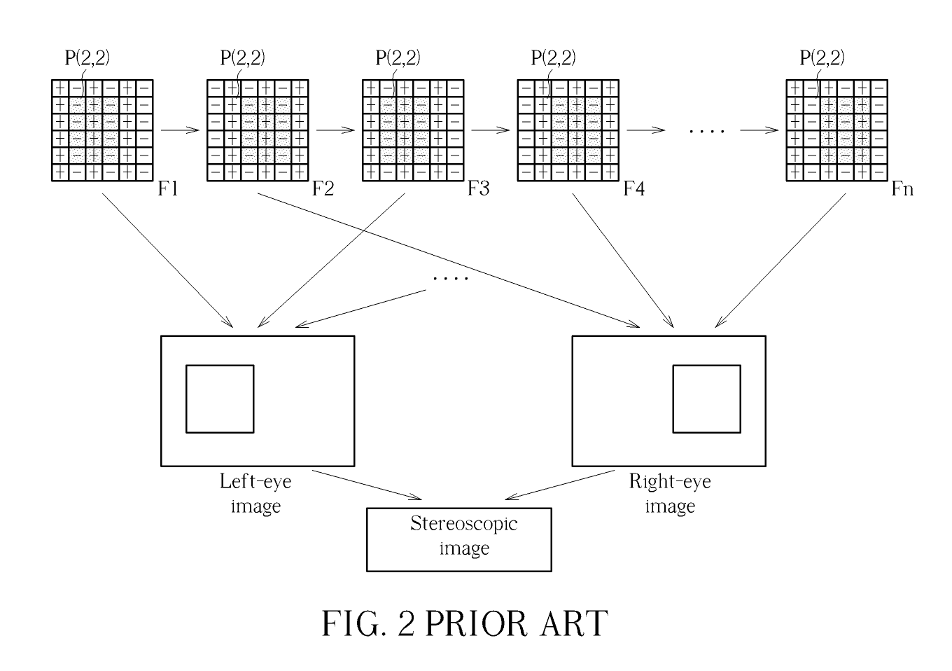

### DETAILED DESCRIPTION

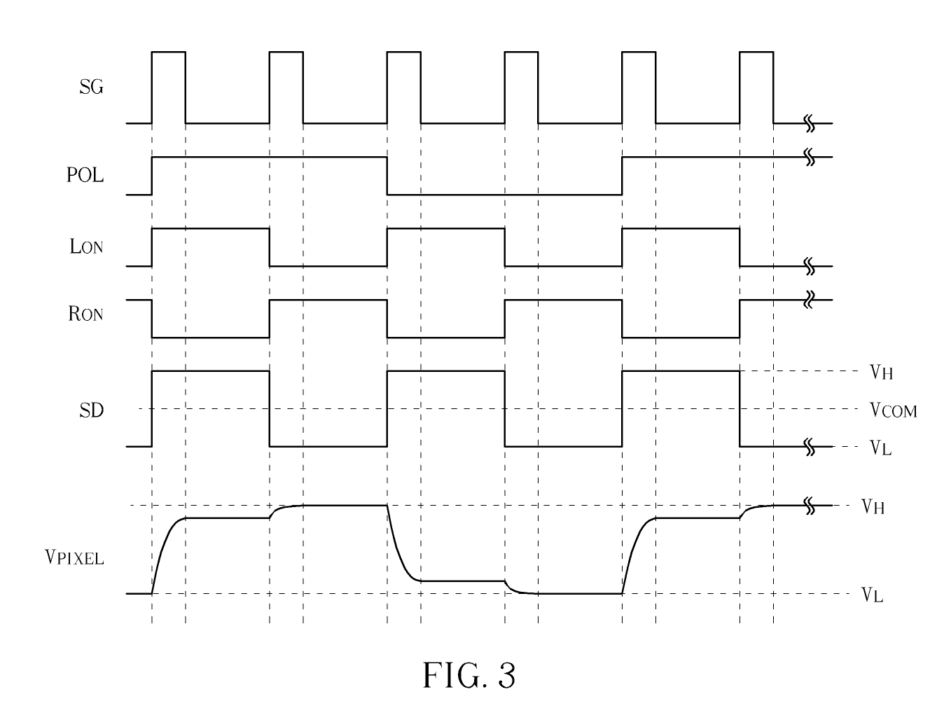

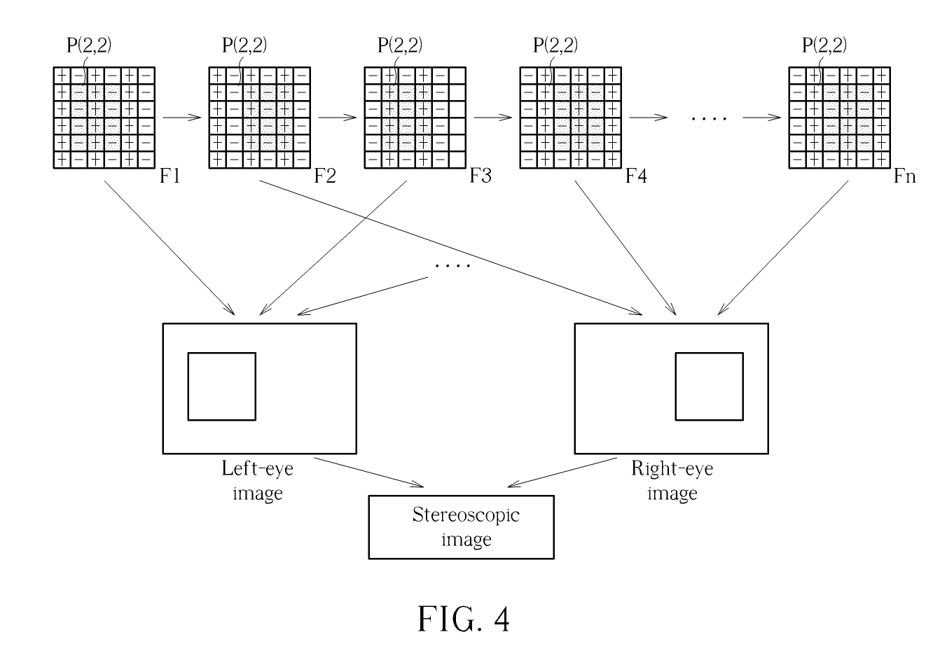

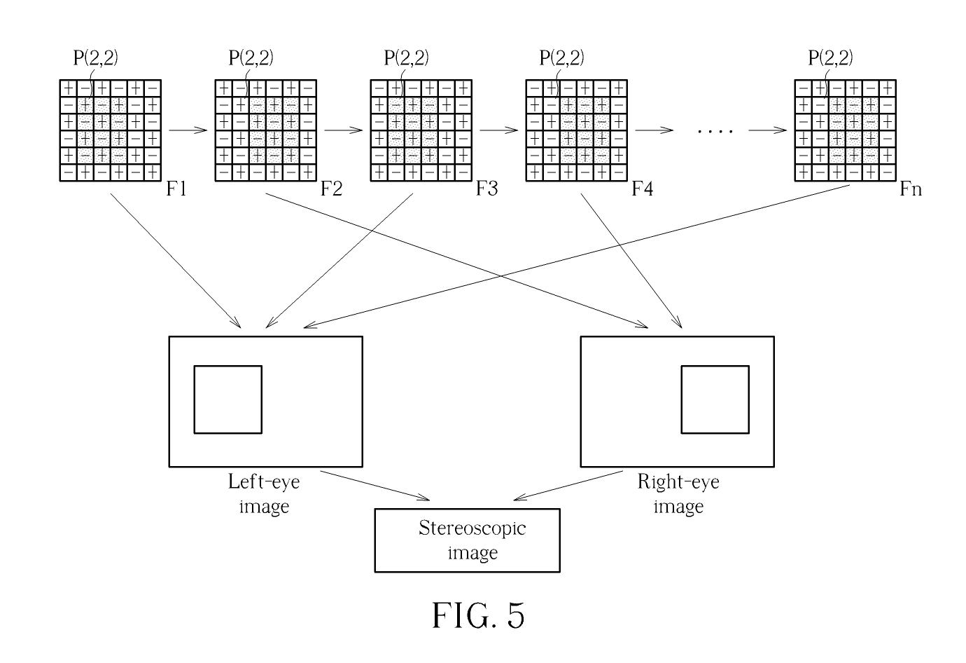

FIGS. 3-5 are diagrams illustrating a method for displaying stereoscopic images using an LCD device according to the present invention. FIG. 3 shows a gate driving signal SG, a data driving signal SD, a polarity inversion signal POL, a pixel voltage V_{PIXEL}, a left-eye lens-on signal L_{ON} and a right-eye lens-on signal R_{ON}. When column inversion is adopted, the data polarities in frame periods F1-Fn are depicted in FIG. 4; when dot inversion is adopted, the data polarities in frame periods F1-Fn are depicted in FIG. 5.

As depicted in FIG. 3, the data driving signal SD is written into a corresponding pixel during the turn-on periods when the gate driving signal SG is at high level. In other words, the pixel charge time is determined by the pulse width of the gate driving signal SG. The polarity of the diving period is determined by the polarity inversion signal POL. During the positive driving period, the level of the data driving signal SD is represented by V_{H}; during the negative driving period, the level of the data driving signal SD is represented by V_{L}. In the present invention, the polarity inversion signal POL switches polarities every two frame periods, thereby providing more time for the pixel voltage V_{PIXEL} to reach the predetermined voltage V_{H} or V_{L}. As previously stated, the grayscale value of an image to be displayed by a pixel is determined by the voltage difference ΔV between the data driving signal SD and the common voltage V_{COM}, wherein ΔV=(V_{H}−V_{COM}) or (V_{COM}−V_{L}) . If the common voltage V_{COM} applied to NW liquid crystal material is 6V, the white image can be displayed by applying a positive driving voltage V_{H} of 7V or a negative driving voltage V_{L} of 5V, while the black image can be displayed by applying a positive driving voltage V_{H} of 11V or a negative driving voltage V_{L} of 1V.

In the present method for displaying stereoscopic image using an LCD device, each column of pixels for displaying the left-eye images during the odd-numbered frame period F1 and displaying the right-eye images during the even-numbered frame period F2 are driven by signals sequentially having positive polarity, negative polarity, . . . , positive polarity, and negative polarity; each column of pixels for displaying the left-eye images during the odd-numbered frame period F3 and displaying the right-eye images during the even-numbered frame period F4 are driven by signals sequentially having negative polarity, positive polarity, . . . , negative polarity, and positive polarity (assuming n is an even number); the same continues for all frame periods. The pixels in the striped region are required to display black images having grayscale value of 0, while the pixels in the blank region are required to display white images having grayscale value of 255.

For the pixel represented by P(2,2) in FIG. 4, the level of the data driving signal SD is equal to the negative driving voltage V_{L} (1V) of black image in the frame period F1, equal to the negative driving voltage V_{L} (5V) of white image in the frame period F2, equal to the positive driving voltage V_{H} (11V) of black image in the frame period F3, equal to the positive driving voltage V_{H} (7V) of white image in the frame period F4, . . . , and etc. In other words, the level of the data driving signal SD changes in the sequence of 1V→5V→11V→7V, and the resulting voltage difference ΔV thus changes in the sequence of −5V→−1V−5V→1 V. Since the voltage differences applied to the pixel between the positive and negative driving periods can be compensated, the present method does not cause DC residual and can largely improve 3D image quality of the LCD device.

For the pixel represented by P(2,2) in FIG. 5, the level of the data driving signal SD is equal to the positive driving voltage V_{H} (11V) of black image in the frame period F1, equal to the positive-polarity driving voltage V_{H} (7V) of white image in the frame period F2, equal to the negative driving voltage V_{L} (1V) of white image in the frame period F3, equal to the negative driving voltage V_{L} (5V) of white image in the frame period F4, . . . , and etc. In other words, the level of the data driving signal SD changes in the sequence of 11V→7V→1V→5V, and the resulting voltage difference ΔV thus changes in the sequence of 5V→1V→−5V—−1 V. Since the voltage differences applied to the pixel between the positive and negative driving periods can be compensated, the present method does not cause DC residual and can largely improve 3D image quality of the LCD device.

In the present stereoscopic image displaying method of the LCD device, the data driving signal SD switches polarities and the left/right-eye lenses are switched on/off with different frequencies. More specifically, the left-eye lens-on signal L_{ON} and the right-eye lens-on signal R_{ON} switch polarities every other frame period, while the polarity inversion signal POL switches polarities every two frame periods. As shown in FIGS. 4 and 5, assuming that the right-eye lens is turned on and the left-eye lens is turned off during the odd-numbered frame periods Fl, F3, . . . , Fn-1, and that the left-eye lens is turned on and the right-eye lens is turned off during the even-numbered frame periods F2, F4, . . . , Fn. The data driving signal SD thus has opposite polarities for two consecutive odd-numbered frame periods and for two consecutive even-numbered frame periods. Therefore, the present method can improve 3D image uniformity of the LCD device when the positive and negative polarities result in difference values in luminance.

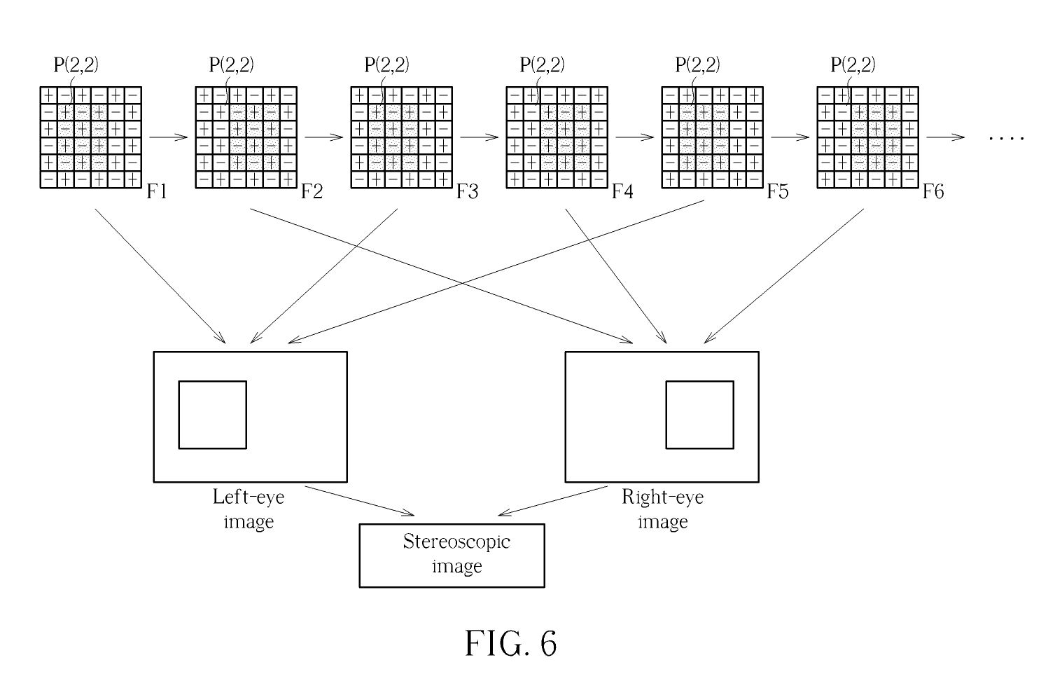

In the present invention, the left-eye lens-on signal L_{ON} and the right-eye lens-on signal R_{ON} may switch polarities every other frame period, while the polarity inversion signal POL may switch polarities every m frame periods. FIG. 3 shows the embodiment when m=3, and FIG. 6 shows the embodiment when m=3. However, FIGS. 3 and 6 do not limit the scope of the present invention. The present invention includes methods for displaying stereoscopic images using an LCD device in which the data driving signal switches polarities less frequently than the switching of left/right-eye images.

In the present invention, stereoscopic images may be displayed by column inversion (as depicted in FIG. 4) or dot inversion (as depicted in FIG. 5). However, since other polarity arrangements in a single frame periods may also be adopted, FIGS. 4 and 5 do not limit the scope of the present invention.

In the present invention, the voltage differences applied to the pixel between the positive and negative driving periods can be compensated. No DC residual is caused and 3D image quality of the LCD device can largely be improved. Meanwhile, the present method can improve 3D image uniformity of the LCD device by outputting data of opposite polarities in two consecutive frame periods for a single eye.

Those skilled in the art will readily observe that numerous modifications and alterations of the device and method may be made while retaining the teachings of the invention.

What is claimed is:

1. A method for displaying stereoscopic images using an LCD device, comprising:
providing a data driving signal corresponding to a right-eye image and a left-eye image;
switching a polarity of the data driving signal every m frame periods during a plurality of frame periods, wherein m is an integer larger than 1;
outputting the right-eye image according to the data driving signal during odd-numbered frame periods among the plurality of frame periods; and
outputting the left-eye image according to the data driving signal during even-numbered frame periods among the plurality of frame period.

2. The method of claim 1 further comprising:
driving the LCD device according to the data driving signal so as to display the right-eye image during the odd-numbered frame periods among the plurality of frame periods; and
driving the LCD device according to the data driving signal so as to display the left-eye image during the even-numbered frame periods among the plurality of frame periods.

3. The method of claim 1 further comprising:
turning on a right-eye lens of a pair of shutter glasses for receiving the right-eye image during the odd-numbered frame periods among the plurality of frame periods; and
turning on a left-eye lens of the pair of shutter glasses for receiving the left-eye image during the even-numbered frame periods among the plurality of frame periods.

4. The method of claim 3 further comprising:
turning off the right-eye lens of the pair of shutter glasses during the even-numbered frame periods among the plurality of frame periods; and
turning off the left-eye lens of the pair of shutter glasses during the odd-numbered frame periods among the plurality of frame periods.

5. The method of claim 1 further comprising:
outputting the right-eye image or the left-eye image during each frame period by means of column inversion.

6. The method of claim 1 further comprising:
outputting the right-eye image or the left-eye image during each frame period by means of dot inversion.

7. The method of claim 1 further comprising:
outputting the right-eye image and the left-eye image according to the data driving period having a same polarity during two consecutive frame periods among the plurality of frame periods.
